(19) United States
(12) Patent Application Publication
(10) Pub. No.: US 2026/0222785 A1
(43) Pub. Date: Jul. 30, 2026

(54) WORKSITE PERSONNEL AND VISITOR SAFETY SYSTEM

(71) Applicant: SAUDI ARABIAN OIL COMPANY, Dhahran (SA)

(72) Inventors: Hussain A. Al Rasheed, Dhahran (SA); Rosa M. Rubui, Dhahran (SA); Adnan F. Aldajani, Dhahran (SA)

(73) Assignee: SAUDI ARABIAN OIL COMPANY, Dhahran (SA)

(21) Appl. No.: 19/039,369

(22) Filed: Jan. 28, 2025

(51) Int. Cl. H04W 4/90; G06V 20/52; G06V 40/10; H04W 4/021

(52) U.S. Cl. CPC H04W 4/90; G06V 20/52; G06V 40/10; H04W 4/021; G06V 2201/08

(57) ABSTRACT

Methods and systems for personnel and visitor safety at worksites. The method includes distributing a wearable device with a GPS sensor, SOS button, and transmitter to a person at a worksite. The method further includes receiving area boundaries that define one or more restricted areas at the worksite and determining, with the wearable device, a location of the person at the worksite, comparing the location of the person to the one or more restricted areas at the worksite, and making a first determination whether the person is in a restricted area. The method further includes making a second determination whether the person has pressed the SOS button of the wearable device. The method further includes generating an alert with the location of the person in response to the first determination that the person is in the restricted area or the second determination that the person has pressed the SOS button.

### BACKGROUND

A worksite can include personnel at the worksite performing various tasks. Further, various visitors can enter and leave the worksite. For example, a driver driving a vehicle can enter the worksite to unload or load materials (e.g., pipes) to, or from, the worksite. In this example, the driver may be considered a visitor to the worksite. Further, a worker can perform the unloading or loading of materials from, or to, the vehicle, e.g., using heavy machinery or equipment such as a forklift. The worker is considered personnel of the worksite. The worksite can include various restricted areas such as areas where a worker and/or visitor may be unsafe due to a worksite hazard. For example, an area where materials are unloaded or loaded to a vehicle can be considered unsafe for visitors such as drivers and other personnel that are not performing the unloading/loading task. The presence of an unauthorized person, whether worksite personnel or a visitor, in a restricted area can result in injury or death to the person and/or damage to equipment or other facility infrastructure of the worksite.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for safety of a person at a worksite. The method incudes distributing a wearable device with a GPS sensor, SOS button, and transmitter to the person at the worksite. The method further includes receiving area boundaries that define one or more restricted areas at the worksite and determining, with the wearable device, a location of the person at the worksite, comparing the location of the person to the one or more restricted areas at the worksite, and making a first determination whether the person is in a restricted area. The method further includes making a second determination whether the person has pressed the SOS button of the wearable device. The method further includes generating an alert with the location of the person in response to the first determination that the person is in the restricted area or the second determination that the person has pressed the SOS button of the wearable device, where the alert dispatches a safety supervisor to the location of the person.

In one aspect, embodiments disclosed herein relate to a method for safety of a visitor at a worksite. The method includes acquiring, using a first camera directed at a gate of the worksite, a first set of images of a vehicle at or passing through the gate. The method further includes determining, based on the first set of images, a vehicle identifier for the vehicle and logging, automatically, to a log, an entry or exit of the vehicle from the worksite based on the vehicle identifier and a direction of travel of the vehicle. The method further includes alerting a visitor desk to distribute or collect a wearable device to or from a driver (i.e., the visitor) of the vehicle according to the log. The method further includes acquiring, using a second camera directed at a docking area of the worksite, a second set of images the vehicle and the driver in response to the vehicle entering the docking area and determining, based on the second set of images, whether the driver has exited the vehicle in the docking area. The method further includes generating an alert to a safety supervisor of the worksite in response to the determination that the driver has exited the vehicle in the docking area, where the alert causes the safety supervisor to be dispatched to the docking area

In one aspect, embodiments disclosed herein relate to a worksite personnel and visitor safety system. The worksite personnel and visitor safety system includes one or more wearable devices, where one wearable device is distributed to each personnel member and visitor of a worksite. Each wearable device includes a GPS sensor, an SOS button, and a transmitter. The worksite personnel and visitor safety system further includes a gate surveillance system that is proximate to a gate of the worksite, where the gate surveillance system includes a first camera and a second camera directed at the gate. The worksite personnel and visitor safety system further includes a dock surveillance system that is proximate to a docking area of the worksite, where the dock surveillance system includes a third camara directed at the docking area. The worksite personnel and visitor safety system further includes a control system with one or more computer processors. The control system is configured to perform the following steps. The steps include obtaining GPS data from each distributed wearable device, where the GPS data includes a location of each distributed wearable device. The steps further include obtaining gate data from the gate surveillance system and obtaining dock data from the dock surveillance system. The steps further include receiving area boundaries that define one or more restricted areas at the worksite and displaying, to a dashboard (of the worksite personnel and visitor safety system) that includes a map of the worksite, the location of each wearable device based on the GPS data of each wearable device. The steps further include making a first determination, based on the GPS data from a first wearable device and the area boundaries, whether the first wearable device has entered a restricted area of the one or more restricted areas. The steps further include generating a first alert with the location of the first wearable device in response to the first determination that the first wearable device has entered the restricted area, where the first alert causes a safety supervisor of the worksite to be dispatched to the location of the first wearable device. The steps further include determining, based on the gate data, a vehicle identifier for a first vehicle at, or passing through, the gate and logging, to a log, an entry or exit of the first vehicle to, or from, the worksite based on the vehicle identifier and an indication of a direction of travel of the first vehicle. The steps further include making a second determination, based on the dock data, whether a driver of a second vehicle at the docking area is outside of the second vehicle. The steps further include generating a second alert to the safety supervisor in response to the second determination that the driver is outside the second vehicle, where the second alert causes the safety supervisor of the worksite to be dispatched to the docking area.

Other aspects and advantages of the claimed subject matter will be apparent from the following description and the appended claims.

### BRIEF DESCRIPTION OF DRAWINGS

FIG. 1 depicts an example worksite in accordance with one or more embodiments.

FIG. 2 depicts a block diagram in accordance with one or more embodiments.

FIG. 3 depicts an example application of a worksite personnel and visitor safety system applied to a worksite in accordance with one or more embodiments.

FIG. 4 depicts an operation of a gate surveillance system of a worksite personnel and visitor safety system in accordance with one or more embodiments.

FIG. 5 depicts an operation of a dock surveillance system of a worksite personnel and visitor safety system in accordance with one or more embodiments.

FIG. 6A depicts a flowchart in accordance with one or more embodiments.

FIG. 6B depicts a flowchart in accordance with one or more embodiments.

FIG. 7 depicts a neural network in accordance with one or more embodiments.

FIG. 8 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “worksite” may include any number of “worksites” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

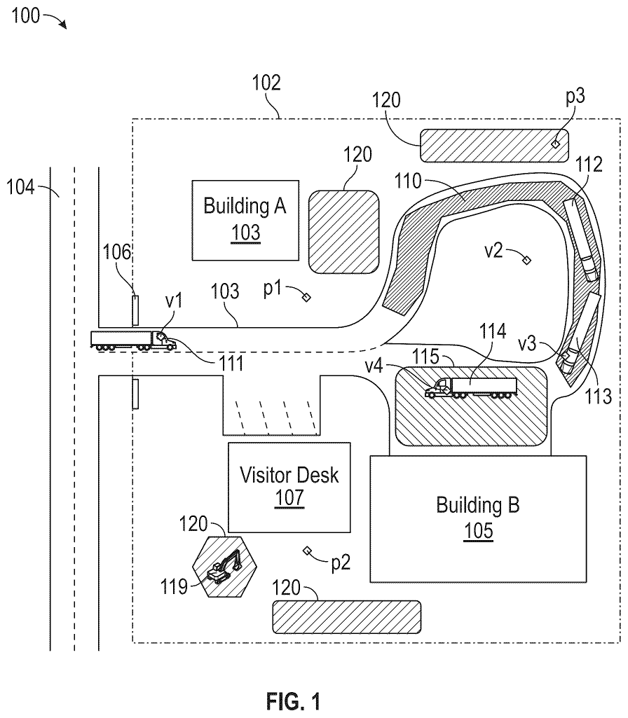

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein relate to a worksite personnel and visitor safety system that determines the presence and location of personnel and visitors at a worksite. The worksite personnel and visitor safety system includes one or more wearable devices. A wearable device is worn by all active personnel at the worksite and visitors upon checking in at a visitor desk of the worksite. Each wearable device includes a global positioning system (GPS) sensor, transmitter, and distress signal button (“SOS button”) for determining and transmitting a location of the user of the device and activating and transmitting a distress signal, respectively. The worksite personnel and visitor safety system further includes a gate surveillance system and a dock surveillance system. The gate surveillance system monitors an entry and/or exit point (access point or “gate”) that is used by visitors to enter and/or leave the worksite. The gate surveillance system can, for example, determine the entry of a visitor to the worksite and indicate that a wearable device is to be supplied to the visitor. The dock surveillance system, as described in greater detail later in the disclosure, monitors an unloading/loading area (“dock” or “docking” area) of the worksite where materials can be unloaded from or loaded to a vehicle (e.g., a vehicle of a visitor such as a delivery driver).

In accordance with one or more embodiments, GPS data, gate data, and dock data are received by a control system of the worksite personnel and visitor safety system from the one or more wearable devices, the gate surveillance system, and the dock surveillance system, respectively. The GPS data, gate data, and dock data can be jointly processed by the control system to determine the location of personnel and visitors of the worksite with respect to restricted areas of the worksite. Restricted areas of the worksite can have a restriction level or categorization. For example, a first restricted area can have a “personnel only” categorization where the first restricted area, defined by a given area boundary, is considered off-limits or restricted to visitors but not to worksite personnel. In one or more embodiments, one or more processes or included systems (e.g., gate surveillance system) of the worksite personnel and visitor safety system makes use of one or more machine learning and/or computer vision models or methods. For example, the gate surveillance system can include a camera that acquires one or more images of the dock area. These images can be processed by a machine learning model to detect the presence of a visitor and further determine a location of the visitor in the worksite and/or with respect to a restricted area, equipment item (which need not be stationary), or other reference point.

FIG. 1 depicts an example worksite (100). The worksite (100) is an area where industry or work tasks occur. The worksite (100) can enclose an indoor area, an outdoor area, or combinations thereof. The worksite (100) is bounded by a perimeter (102). The perimeter can consist of a fence, a geographic feature (e.g., a river), or be without visible demarcation (e.g., a property line), or combinations thereof. The depicted example worksite (100) includes various buildings (e.g., Building A (103), Building B (105), Visitor Desk (106)) and a first road (104) that allows vehicle access to portions of the worksite (100). In general, entry and exit to and from a worksite (100) is provided using one or more access points (“gates”). FIG. 1 depicts a single gate (106) allowing entry and exit of vehicles, personnel, and visitors to and from the worksite (100) by means of a second road (104) external to the worksite (100). The worksite (100) is configured to receive and/or export materials (e.g., physical goods). Materials can be moved into, throughout, and out of the worksite (100) according to the processes of the worksite (100) and the needs and purposes of an organization associated with or governing the worksite (100) (e.g., a company). Movement of materials into or out of the worksite (100) can be facilitated using vehicles such as delivery trucks, boats, trains, etc. Further, materials can be moved within the worksite (100), or unloaded or loaded onto various vehicles, using other vehicles or materials handling equipment in the worksite (100) such as a forklift (not shown) or tractor (119). FIG. 1 depicts various delivery trucks (111, 112, 113, 115) at different locations in the worksite (100). Specifically, a first delivery truck (111) is shown entering the worksite (100) through the gate (106), a second delivery truck (112) and third delivery truck (113) are shown in a queue area (110), and a fourth delivery truck (114) is shown in a docking area (115). The docking area (115) includes, contains, bounds, or otherwise represents an area where unloading and/or loading activities of materials, e.g., from a delivery truck, are designated to occur. Similarly, the queue area (110) includes, contains, bounds, or otherwise represents an area where one or more vehicles (e.g., delivery trucks) can wait before entering the docking area (115). FIG. 1 depicts the docking area (115) adjacent to a building (e.g., Building B (105)) and further depicts the queue area (110) along a portion of the first road (104) leading up to the docking area (115). However, the queue area (110) and docking area (115) are not limited to being located on roads or near buildings but can be located, for example, in buildings (e.g., a warehouse) or on bodies of water (e.g., ocean).

FIG. 1 further depicts various restricted areas (120). A restricted area can include, contain, or bound a portion of the worksite (100) where human access should be restricted to some degree. For example, a restricted area (120) can represent an area that is unsafe or, if inappropriately accessed by a person, could result in injury or death to the person, other persons, or damage to equipment, facilities, or infrastructure included in the worksite (100). Restricted areas (120) can include one or more of the docking area (115) and the queue area (110), although FIG. 1 does not explicitly label the docking area (115) and queue area (110) as restricted areas (120).

Zero or more persons can be present at the worksite (100), i.e., located within the perimeter (102) of the worksite (100). Persons at a worksite (100) can be distinguished as personnel and visitors, where personnel are considered as those persons that work at the worksite (e.g., employed by the organization or company associated with the worksite) and visitors are those persons that may temporarily (e.g., for a portion of a day) be present at the worksite (e.g., drivers of delivery trucks). FIG. 1 depicts the locations of personnel (p1, p2, p3) and a visitors (v1, v2, v3, v4) at the worksite (100). The visitors (v1, v2, v3, v4), for example, may be drivers of delivery trucks. FIG. 1 depicts that the visitor labelled as v2 (that is the driver of the second delivery truck (112)) has exited the delivery truck and is roaming about the worksite (100). FIG. 1 further depicts that the personnel member labelled p3 has entered, or is located in, a restricted area (120).

One with ordinary skill in the art will appreciate that the description of a worksite and accompanying figure (FIG. 1) is intended to be readily generalized to other configurations of worksites, e.g., including worksites that are not predominately on land (e.g., shipyard) or having a different layout (e.g., more or fewer buildings, roads, gates, etc.). That is, the example worksite (100) of FIG. 1 is provided to promote clarity in the later discussion of the worksite personnel and visitor safety system and should not be considered limiting.

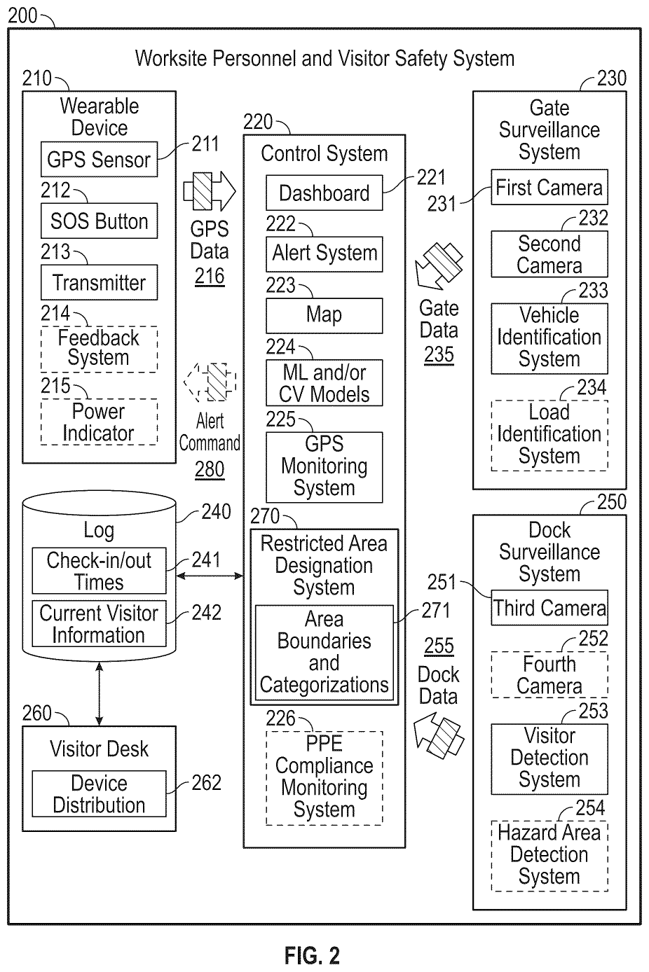

FIG. 2 depicts the worksite personnel and visitor safety system (200), in accordance with one or more embodiments. FIG. 2 depicts, as a block diagram, various components, modules, and/or subsystems, where the components, modules, and/or subsystems may interact with each other. For example, in FIG. 2, a database or other memory system containing a log (240) is shown to interact with a control system (220) and a visitor desk (260) (e.g., a computer located at the visitor desk (107) of FIG. 1). One with ordinary skill in the art will recognize that the partitioning, organization, and interaction of the components, modules, and/or subsystems of the worksite personnel and visitor safety system (200), alongside interactions within said components, modules, and/or subsystems, in FIG. 2, is intended to promote clear discussion and should not be considered fixed or limiting. For example, FIG. 2 depicts the log (240) as an independent entity, however, in some embodiments, the log (240) may be encompassed by or included in the control system (220).

In accordance with one or more embodiments, the worksite personnel and visitor safety system (200) includes a set of one or more wearable devices. A wearable device (210) from the set of one or more wearable devices is distributed to each personnel member and visitor of the worksite (100). In one or more embodiments, each wearable device has a unique identifier (e.g., identification number). In some embodiments, the identifier of each wearable device indicates whether the wearable device is used by a personnel member or a visitor. In other embodiments, a database or relational table is used to relate the identifier of a wearable device to personnel (or to a specific personnel member) or to a visitor. A wearable device (210) can be assigned to a personnel member and put on and worn throughout their shift. Similarly, a wearable device (210) can be temporarily provided to a visitor of the worksite upon checking in at a visitor desk (260), described in greater detail below. The visitor, immediately prior to leaving the worksite (100) returns the wearable device (210) to the visitor desk (260).

In one or more embodiments, the wearable device (210) consists of a housing and at attachment mechanism such that a person can wear the wearable device (210). The housing contains all components necessary for effectuating the functions of the wearable device (210), described later in the instant disclosure. In one or more embodiments, the housing is configured to protect its internal components from potential environmental conditions such as moisture (e.g., rain), dust or dirt, ultraviolet radiation (e.g., sun exposure), electricity, loud sounds, vibrations, impacts, etc. That is, the housing is reasonably weather-proof and robust (e.g., rigid). In one or more embodiments, the housing has an ergonomic profile and is approximately the size of a modern cell phone or smaller. Examples of attachment mechanisms include, but are not limited to, a belt, a belt clip, a wrist band, and a magnetic clip. In one or more embodiments, the wearable device (210) is configured to be worn by a person without limiting the range of motion of the person or requiring the use of their hands (i.e., a “hands-free” device). For example, in some implementations, the wearable device (210) is worn on a shoulder of a person using the attachment mechanism (e.g., a clip).

The wearable device (210) further includes an energy supply (not shown), such as a rechargeable battery that provides power to the components of the wearable device (210). The wearable device (210) includes a GPS sensor (211). The GPS sensor (211) uses trilateration to calculate the location of the wearable device (210) based on received satellite signals. In one or more embodiments, the GPS sensor (211) determines the location of its wearable device (210) as coordinates including a longitude and a latitude. The wearable device (210) further includes an SOS button (212). The SOS button (212) is configured to receive a user input and transmit a distress signal (i.e., a signal indicating an emergency) to relevant parties of the worksite (100) such as worksite supervisors and emergency personnel (e.g., emergency medical technicians). The SOS button (212) can be any type of “button” known in the art, such as a physical button that is depressed by a user through application of a force, a switch, and a touch button or graphical button provided on a touch screen. In some implementations, the SOS button (212) must be enabled or activated (e.g., pressed) for a contiguous time exceeding a predefined threshold (e.g., five seconds) before the issuing the distress signal. In some implementations, the distress signal—once activated using the SOS button (212)—remains active (e.g., is continually transmitted) until deactivated or cancelled using the wearable device. For example, in some implementations, the distress signal is deactivated using the SOS button (212) (e.g., holding the SOS button until the signal is deactivated, pressing the SOS button (212) multiple times in quick succession, etc.). That is, in some implementation the SOS button (212) is “function overloaded,” allowing for the implementation of different functions based on the reception of different types of user inputs. The distress signal includes, at least, the location information (or GPS data) of the issuing wearable device (210) and a distress indicator (e.g., a binary flag, header information, etc.) that distinguishes the distress signal from general location data. Thus, use of the SOS button (212) sends location information (or GPS data) of the issuing wearable device (210) to relevant parties. In one or more embodiments, the distress signal is transmitted to and received by a control system (220) of the worksite personnel and visitor safety system (200). Then, the control system (220) can alert relevant parties such as medical personnel and worksite supervisors.

The wearable device (210) further includes a transmitter (213). The transmitter (213) can transmit one or more of the location of the wearable device (210) (determined using the GPS sensor (211)) and the distress signal (activated using the SOS button (212)). In one or more embodiments, the transmitter (213) transmits GPS data (216) indicative of the current location of the wearable device (210) to the control system (220) of the worksite personnel and visitor safety system (200). In one or more embodiments, the GPS data (216) is transmitted using the transmitter (213) according to a predefined temporal frequency or periodicity. For example, the GPS data (216) can be transmitted once every 1 second, once every 5 seconds, or once every 30 seconds (or according to some other predefined period). Thus, in one or more embodiments, the control system (220) is said to have an up-to-date, real-time, or near real-time location of the wearable device (210). In some embodiments, the transmitter (213) further transmits the identifier (e.g., identification number) of the wearable device (210), e.g., with or as part of the GPS data (216). The transmitter (213) of the wearable device (210) facilitates communication with other devices and/or the control system using one or more of RFID, NFC, low-energy Bluetooth, low-energy wireless, low-energy radio protocols, LTE-A, and WiFi-Direct technologies.

In one or more embodiments, the wearable device (210) further includes one or more of a feedback system (214) and a power indicator (215). The feedback system (214) and power indicator (215) are not required to realize the general function of the worksite personnel and visitor safety system (200) and are indicated a optional in FIG. 2 using dashed boxes. The feedback system (214) is configured to provide feedback to the user of the wearable device using one or more of audio, visual, and haptic feedback. For example, the feedback system (214) can generate an audible tone, vibrate, produce a light (e.g., flashing light), or combinations thereof. In one or more embodiments, the feedback system is activated, or produces its form of user feedback, in response to:1) the activation or enabling of the distress signal using the SOS button (212); and 2) the reception of an alert command (280). The alert command (280) is described in greater detail later in the instant disclosure. For example, in response to a user using the SOS button (212) to activate a distress signal, the feedback system (214) can produce an audible tone indicating to the user that the distress signal is active. The audible tone can also be used by responding personnel (e.g., emergency medical technicians) to quickly determine the precise location of the user of the wearable device (210) upon arriving at the general location of the wearable device (210). Similarly, the wearable device (210) may also emit a visual signal (e.g., a flashing light) using the feedback system (214) that can aid responding personnel in determining the precise location of the user in the event of an emergency (e.g., activation of distress signal using the SOS button (212)). The power indicator (215) indicates the presence or state of power in the wearable device (210) and/or the remaining runtime of the wearable device (210). For example, in some implementations, the wearable device is powered using one or more rechargeable batteries included the wearable device (210) and the charge level of the one or more rechargeable batteries is indicated using the power indicator (215). As another example, the power indicator (215) indicates whether the wearable device is “on” or “off.” The power indicator (215) can be a light (e.g., a light emitting diode) disposed on or visible on the housing of the wearable device (210). The power indicator (215) can be a graphic, or dynamically updated display icon, readable by the user using a display or graphical user interface of the wearable device (210).

In accordance with one or more embodiments, the worksite personnel and visitor safety system (200) includes a control system (220). The control system (220) is configured to receive various data structures (e.g., GPS data (216)), process the data structures to determine, among other things, a state and/or location of one or more personnel members and visitors in the worksite, and, in some instances, transmit command signals to control or affect other components of the worksite personnel and visitor safety system (200). Continuing with FIG. 2, the depicted control system (220) includes a dashboard (221). The dashboard visually displays information to an operator of the worksite personnel and visitor safety system (200). The operator of the worksite personnel and visitor safety system (200) can be a worksite supervisor, manager, or other designated personnel member (e.g., safety supervisor). In one or more embodiments, the dashboard includes a display (e.g., computer monitor) accessible to the operator of the worksite personnel and visitor safety system (200). In some embodiments, the dashboard can further include various input devices, such as keyboard, mouse, joystick, control panel, or combinations thereof, for the operator of the worksite personnel and visitor safety system (200) to interact with the control system (220). In accordance with one or more embodiments, the control system (220) includes, or is otherwise informed by, a map (223) of the worksite. The map (223) can be, for example, an overhead illustration of the worksite similar to that depicted in FIG. 1. The map (223) can be displayed to the operator of the worksite personnel and visitor safety system (200) using the dashboard (221). In one or more embodiments, the control system (220) receives GPS data (216) from one or more wearable devices worn by personnel and/or visitors at the worksite, and displays the locations of the personnel and/or visitors on (or in relation to) the map (223), where the map is displayed and/or made interactive using the dashboard (221). Thus, using the worksite personnel and visitor safety system (200), the locations of personnel and visitors at a worksite are determined.

In one or more embodiments, the control system (220) further includes restricted area designation system (270) and a GPS monitoring system (225). The restricted area designation system (270) allows the operator of the worksite personnel and visitor safety system (200) to define restricted areas of the worksite, e.g., by drawing boundaries of restricted areas on the map (223). Additionally, in some embodiments, the restricted area designation system (270) further allows the operator of the worksite personnel and visitor safety system (200) to assign a category or restriction level to each restricted area. The category or restriction level can specify which personnel members and/or visitors are allowed (or not allowed) into the associated restricted area. For example, for a first restricted area, defined according to an area boundary by the operator, the operator can indicate that access to the first restricted area is permitted to personnel but not to visitors. As another example, the operator can define a second restricted area where access to the second restricted area is only permitted to designated personnel either based on a individual basis or using an access level associated with each personnel member. Thus, the restricted area designation system (270) allows an operator of the worksite personnel and visitor safety system (200) to define restricted areas at least based on a boundary or area representation of the restricted area (e.g., with respect to the map (223)) and in some instances further allows the operator to specify a categorization or restriction level for each restricted area. Thus, these defining features of restricted areas may be stored as area boundaries and categorizations (271) in the restricted area designation system (270). An operator can update area boundaries and categorizations (271) for one or more restricted areas using the restricted area designation system (271). Further, the operator can create new restricted areas and remove or delete restricted areas. Thus, the restricted area designation system (270) allows for restricted areas of a worksite to be updated according to the needs of the worksite. In some embodiments, a restricted area can be dynamically updated, for example, based on the movement of an equipment item configured with a GPS sensor and transmitter. For example, a tractor or forklift can transmit GPS data to the control system (220) and the restricted area designation system (270) can be used to define a restricted area that encloses the tractor or forklift as the tractor or forklift moves. This dynamic restricted area may further include a categorization or restriction level that allows users or operators of the tractor or forklift (or other equipment item) to access the dynamic restricted area. That is, personnel with permission to operate a stated equipment item can enter a restricted area defined by the equipment item without violating a restricted area ruleset.

The GPS monitoring system (225) has access to the area boundaries and categorizations (271) (i.e., definitions of the restricted areas) of the restricted area designation system (270). The GPS monitoring system (225) processes the GPS data (216) received from a wearable device (210) to determine if the wearable device (210)—and its user—is in a restricted area. In instances where the GPS monitoring system (225) determines that the wearable device is in a restricted area, the GPS monitoring system (225) further determines whether the wearable device and its user are permitted in the restricted area according the categorization or restriction level of the restricted area, if applicable. In summary, the GPS monitoring system (225), using the GPS data (216) (which can include a wearable device identifier) and area boundaries and categorizations (271) determines whether a wearable device (210) and its user are in an unpermitted area, i.e., committing a violation.

In accordance with one or more embodiments, the control system (220) further includes an alert system (222). The alert system (222), among other things, generates an alert to the operator of the worksite personnel and visitor safety system (200) in response to a determined violation. In one or more embodiments, the alert system (222) displays the location of the offending wearable device (210) and its user on the map (223) using the dashboard (221). Further, the alert system (222) can produce an audible tone or other feedback mechanism (e.g., an SMS message) to the operator of the worksite personnel and visitor safety system (200) and/or other personnel (e.g., safety manager, nearest personnel member based on evaluation of the GPS data of each wearable device). In some embodiments, the alert system (222) causes the dispatching of a worksite supervisor or safety manager to the location of a wearable device (210) and its user having entered an unpermitted area (e.g., restricted area or restricted area without proper access designation). In one or more embodiments, the alert system (222) further generates an alert command (280) that is transmitted to the offending wearable device (210). The alert command (280) can activate or control the feedback system (214) of the wearable device (210) to alert the user that they are in violation of specified restricted area rules. For example, an audible tone can be emitted by the wearable device (210) using its feedback system (214) indicating to the user that they need to exit a restricted area in response to receiving an alert command (280); the alert command (280) originating from the control system (220) having determined that the wearable device (210) is not allowed in the restricted area using the GPS data (216) of the wearable device (210).

In accordance with one or more embodiments, the worksite personnel and visitor safety system (200) further includes a gate surveillance system (230). The gate surveillance system (230) includes two cameras (or other imaging device), namely, a first camera (231) and a second camera (232). The first camera (231) and the second camera (232) are configured to acquire one or more images (e.g., a continuous video stream, a small number of images based on a trigger such as a motion sensor, etc.) of a gate of the worksite. In one or more embodiments, the first camera (231) and the second camera (232) are set at different heights to image vehicles (e.g., delivery trucks) of different heights or image different portions of the vehicle. For example, the first camera (231) can be positioned at a height to image a bumper (e.g., front bumper, tailgate, etc.) of a vehicle where the bumper of the vehicles includes an attached identification plate for the vehicle. Continuing with this example, the second camera (232) can be positioned at a height above the vehicle to acquire one or more images of a load or materials carried by the vehicle.

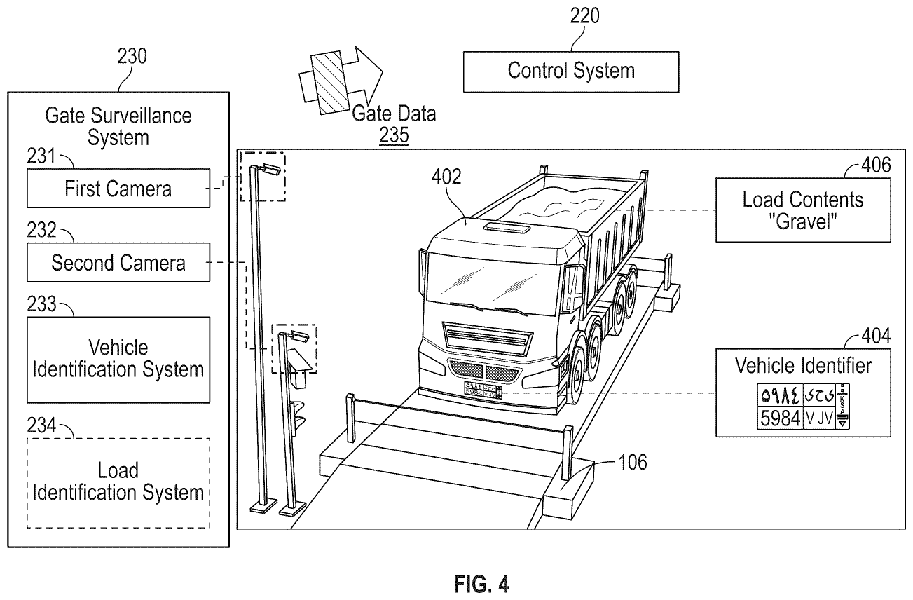

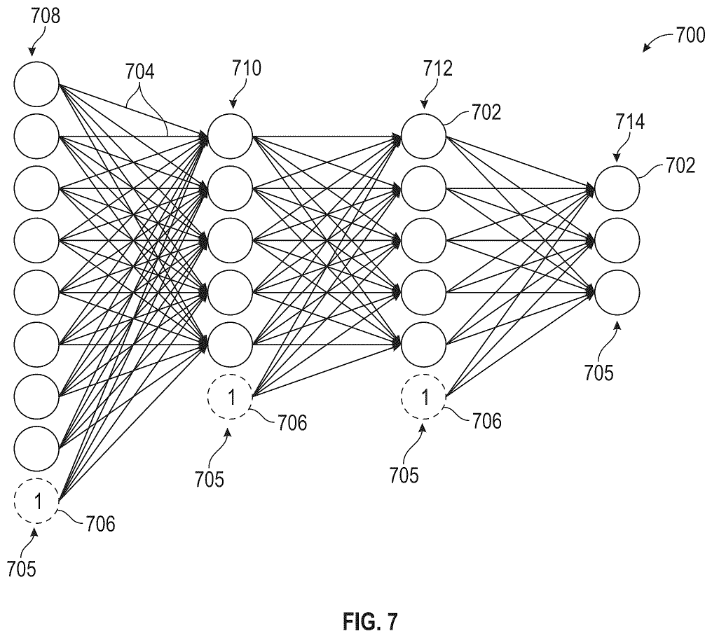

The gate surveillance system (230) further includes a vehicle identification system (233). The vehicle identification system (233) processes image data acquired from the first camera (231) and/or second camera (232) to identify a vehicle entering or exiting the worksite by the gate. In one or more embodiments, the vehicle identification system (233) uses one or more machine learning (ML) models, one or more computer vision (CV) algorithms, or a combination thereof, to identify a vehicle entering or exiting the worksite using the gate based on one or more images acquired using the first camera (231) and/or the second camera (232). The one or more ML models and one or more CV algorithms can be included in the vehicle identification system (233) or considered part of the control system (220). FIG. 2 depicts the control system including ML and/or CV models (224) that include the one or more ML models and one or more CV algorithms used for the task of vehicle identification. For example, in or more embodiments, one or more images of a vehicle acquired using the first camera (231) and/or second camera (232) are processed using computer vision techniques such as optical character recognition to convert a portion of an image or images containing a vehicle identifier such as a license plate to a machine-readable text format. In other words, image data is processed to read or determine the license plate number of a vehicle entering or exiting a gate of the worksite. Other vehicle identifiers can be used including barcodes or look-up tables where features of a vehicle detected and determined using the ML and/or CV models (224) (e.g., blue, 18 wheels, etc.) are compared with a database that relates the features to given vehicle identifiers (e.g., vehicle is from Company A). In some embodiments, the gate surveillance system (230) further makes use of other scanning systems such as RFID readers to identify vehicles at the gate. Use of the gate surveillance system (230) to identify a vehicle at a gate of the worksite is described with respect to FIG. 4. Further, a greater description of machine learning (ML) is provided with respect to FIG. 7.

In some embodiments, the gate surveillance system (230) further includes a load identification system (234). The load identification system (234) operates similarly to the vehicle identification system (233) and in some embodiments the load identification system (234) and the vehicle identification system (233) are one and the same. The load identification system (234) uses one or more machine learning (ML) models, one or more computer vision (CV) algorithms, or a combination thereof, to identify the load or materials carried (or lack of a load or materials carried) by a vehicle entering or exiting the worksite using the gate based on one or more images acquired using the first camera (231) and/or the second camera (232). The one or more ML models and one or more CV algorithms can be included in the load identification system (234) or considered part of the control system (220) (e.g., ML and/or CV models (224)).

In one or more embodiments, the gate surveillance system (230) transmits gate data (235) to the control system (220). In some implementations, the gate data (235) includes one or more images acquired by the gate surveillance system (230), for example, to be processed using the ML and/or CV Models (224). In other implementations, the gate data (235) includes vehicle identifier data and/or load data relating to a vehicle at the gate, where the identifier data and/or load data are determined by processing one or more acquired images at the gate surveillance system (230) itself (e.g., a native or local computing system).

The worksite personnel and visitor safety system (200) further includes a dock surveillance system (250). The dock surveillance system (250) includes at least one camera (or other imaging device). FIG. 2 depicts the dock surveillance system (250) has having a third camera (251) and an optional fourth camera (252). As described below, the dock surveillance system (250) acquires one or more images of the docking area (i.e., an area where loading and unloading operations are performed). In instances where more than one camera is used by the dock surveillance system (250) (e.g., a third camera (251) and a fourth camera (252)), images acquired from each camera can be considered jointly to determine the depth, distance (including relative distance), and/or orientation of objects visible in or captured by the cameras. For example, the more than one cameras can be positioned to monitor the same location (the docking area) while being separated by a known distance and associated images (e.g., acquired at the same time) from the more than one cameras can be analyzed using stereoscopic techniques in view of the known separation distance to determine a distance between objects.

The dock surveillance system (250) further includes a visitor detection system (253). The visitor detection system (253) processes image data acquired from the third camera (251), and additional cameras (e.g., fourth camera (252)) if present, to detect a visitor. In one or more embodiments, the dock surveillance system (250) is configured to detect additional objects such as equipment items. Further, in some embodiments, the dock surveillance system (250) is further configured to determine a spatial relationship between detected objects, such as the distance between a detected visitor and a detected equipment item (e.g., tractor, forklift, vehicle, etc.). The spatial relationship of detected objects can be determined using associated images (i.e., acquired at the same time) acquired from more than one camera used by the dock surveillance system (250) as described above.

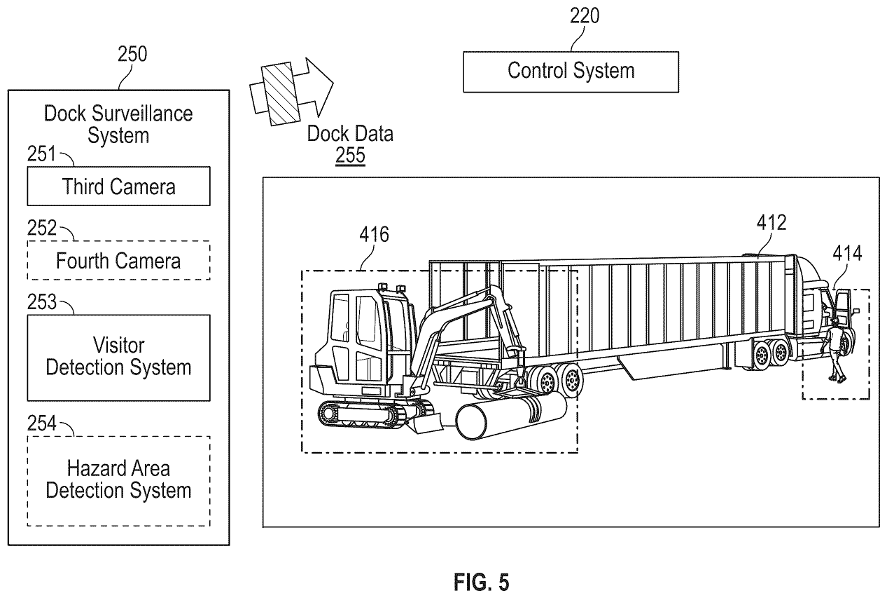

In one or more embodiments, the visitor detection system (253) uses one or more machine learning (ML) models, one or more computer vision (CV) algorithms, or a combination thereof, to detect a visitor (and possibly other objects) in the docking area based on one or more images acquired using the third camera (251) and additional cameras (e.g., fourth camera (252)) if present. The one or more ML models and one or more CV algorithms can be included in the visitor detection system (253) or considered part of the control system (220). FIG. 2 depicts the control system including ML and/or CV models (224) that include the one or more ML models and one or more CV algorithms used for the task of visitor detection. Use of the visitor detection system (253) to detect a visitor in the docking area is described with respect to FIG. 5. Further, a greater description of machine learning (ML) is provided with respect to FIG. 7.

In some embodiments, the dock surveillance system (250) further includes a hazard area detection system (254). The hazard area detection system (254) operates similarly to the visitor detection system (253) and in some embodiments the hazard are detection system (254) and the visitor detection system (253) are one and the same. The hazard area detection system (254) uses one or more machine learning (ML) models, one or more computer vision (CV) algorithms, or a combination thereof, to detect an area containing a hazard. A detected hazard area can be common to a restricted area. That is, hazard areas and restricted areas are not mutually exclusive. The hazard area detection system (254) uses one or more images acquired using the third camera (251), and other cameras if included in the dock surveillance system (250). The one or more ML models and one or more CV algorithms can be included in the load identification system (234) or considered part of the control system (220) (e.g., ML and/or CV models (224)). In one example, the hazard detection system (254) detects a tractor in the docking area as a hazard area and the visitor detection system (253) detects a visitor in the tracking area and the detected results (tractor (or hazard area) and visitor) are compared to determine whether the visitor is at an unsafe distance from the tractor. As discussed above, in some implementations, the visitor detection system (253) can also detect other objects (e.g., hazard areas) besides visitors. Thus, in these implementations, the hazard area detection system (254) may be said to be included in the visitor detection system (253) or the visitor detection system (253) may be said to perform the functions of the hazard area detection system (254).

In one or more embodiments, the dock surveillance system (250) transmits dock data (255) to the control system (220). In some implementations, the dock data (255) includes one or more images acquired by the dock surveillance system (250), for example, to be processed using the ML and/or CV Models (224). In other implementations, the dock data (255) includes visitor detection data and/or hazard area data relating to one or more detected visitors and hazards (e.g., equipment items), respectively, in the docking area. This these implementations the visitor detection data and/or hazard area data are determined by processing one or more acquired images at the dock surveillance system (250) itself (e.g., a native or local computing system).

In one or more embodiments, the visitor detection system (253) and/or hazard area detection system (254) are applied to, or used to process, images acquired from other cameras not directed at a docking area. That is, in one or more embodiments, the worksite personnel and visitor safety system (200) includes additional cameras distributed throughout the worksite beyond those described with respect to the gate surveillance system (230) and the hazard area detection system (254). Thus, the location of visitors (and their relationship to hazards and/or restricted areas) can be determined and tracked, even without the use of a wearable device (210) (e.g., visitor left the wearable device in a delivery vehicle and then proceeded to roam about the worksite).

In one or more embodiments, images acquired using the cameras of the worksite personnel and visitor safety system (200), regardless of their designation (e.g., camera of the dock surveillance system (250)), can be used to determine the location of personnel and visitors in the worksite even without the use of wearable devices (210). The locations of personnel and visitors can be displayed using the dashboard (221) and alerts can be generated in response to triggering events (e.g., violations) as previously described. Thus, in one or more embodiments, the worksite personnel and visitor safety system (200) provides a “back-up” or redundant method for determining the location of personnel and visitors (and their relationship to restricted areas) in instances where GPS data (216) is not available.

Keeping with FIG. 2, the worksite personnel and visitor safety system (200) further includes a visitor desk (260). In one or more embodiments, the visitor desk (260) includes a physical facility (e.g., a building) proximate to the gate of the worksite or on a path between the gate and a docking area. Visitors, upon entering the worksite via a gate, are expected to check-in at the visitor desk (260) and receive a wearable device (210) (i.e., device distribution (262)). Similarly, immediately prior to leaving the worksite visitors are expected to check-out at the visitor desk (260) and return their wearable device (210).

In accordance with one or more embodiments, one or more check-in steps (e.g., all check-in processes other than device distribution (262)) are automated using the gate surveillance system (230) and control system (220). For example, in one or more embodiments, the worksite personnel and visitor safety system (200) further includes a log (240) (e.g., database, memory, etc.) wherein the check-in and check-out times (241) of all visitors are recorded as they enter and exit the worksite, respectively. Traditionally, such a log (240) is updated manually as a visitor uses the visitor desk (260). However, in accordance with one or more embodiments, the gate surveillance system (230) and control system (220) determine that a visitor has entered (or exited) the worksite, identify the visitor (e.g., vehicle identification system (233)) and automatically log the check-in/out times (241) of the visitor in the log (240). Further, the control system (220), gate surveillance system (230), and log (240) can be used to determine whether a visitor has bypassed the visitor desk (260), e.g., failing to receive or return a wearable device, and generate an alert (e.g., alert system (222)) to take appropriate action. In one or more embodiments, the log (240) further contains, or is used to generate, a list of current visitor information (242). Thus, knowledge of visitors currently at the worksite is always up-to-date and readily accessible.

In one or more embodiments, the worksite personnel and visitor safety system (200) further includes a personal protective equipment (PPE) compliance monitoring system (226); depicted in FIG. 2 as an optional feature effectuated using the control system (220). The PPE compliance monitoring system (226) processes image data acquired from a specified set of cameras disposed throughout the worksite. The set of cameras can include the cameras of the gate surveillance system (230), the dock surveillance system (250), and other cameras. The PPE compliance monitoring system (226) is configured to determine whether personnel (and, in some instances, visitors) are wearing or properly equipped with PPE (e.g., hardhat).

In one or more embodiments, the PPE compliance monitoring system (226) uses one or more ML models, one or more CV algorithms, or a combination thereof, to detect persons and determine their PPE compliance based on one or more images acquired using the specified set of cameras disposed throughout the worksite. The one or more ML models and one or more CV algorithms can be included in the PPE compliance monitoring system (226) or considered part of ML and/or CV models (224) of the control system (220). In response to a determination that a personnel member (or possibly a visitor) is not wearing or properly equipped with their PPE, the control system (220) can generate an alert (e.g., alert system (222)) to inform a responsible party (e.g., supervisor, safety manager, etc.) of the violation and the current location of the non-compliant person.

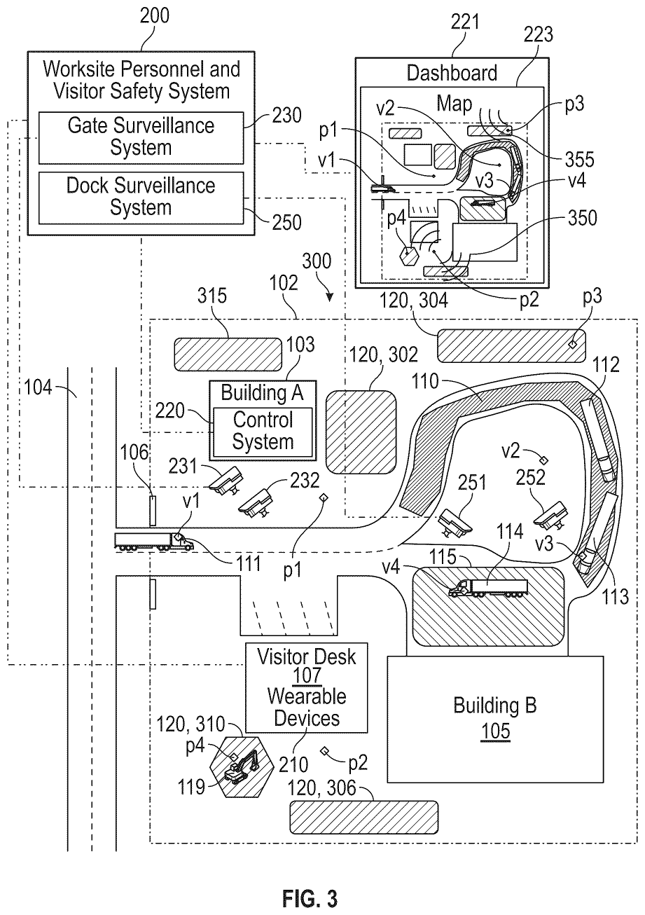

FIG. 3 depicts an example implementation of a worksite personnel and visitor safety system (200), as described above in reference to FIG. 2, with respect to the worksite of FIG. 1. To distinguish between FIG. 1, FIG. 3 is said to depict a “safety system worksite” (300), however, where appropriate, like numeric labels are shared between FIGS. 1 and 3. As in FIG. 1, the safety system worksite (300) of FIG. 3 is bounded by a perimeter (102) with entry and exit to the worksite provided by a gate (106). The safety system worksite (300) includes various buildings (e.g., Building A (103), Building B (105), Visitor Desk (106)) and a first road (104) that allows vehicle access to portions of the worksite (100) such as a queue area (110) and a docking area (115). FIG. 3 depicts various delivery trucks (111, 112, 113, 115) at different locations in the safety system worksite (300). Further, FIG. 3 depicts the locations of various personnel (p1, p2, p3, p4) and visitors (v1, v2, v3, v4). FIG. 3 also depicts various components of the worksite personnel and visitor safety system (200), however, not all components are shown to avoid cluttering the figure.

FIG. 3 further depicts various restricted areas (120). In contrast to FIG. 1, these restricted areas are labelled in FIG. 3 as a first restricted area (302), a second restricted area (304), a third restricted area (306). The first, second, and third restricted areas (302, 304, 306) are defined by the area boundaries and categorizations (271) by an operator of the worksite personnel and visitor safety system (200) using the restricted area designation system (270). In the example of FIG. 3, it is said that the first, second, and third restricted areas (302, 304, 306) are restricted to all visitors and personnel. FIG. 3 also depicts a dynamic restricted area (310) defined using the restricted area designation system (270). The dynamic restricted area (310) is related spatially to the location of the tractor (119). In the depicted example, the dynamic restricted area (310) is centered on the tractor (119) and moves with movements of the tractor (119). In one or more embodiments, the location of the tractor—and thus the dynamic restricted area (310)—is determined by the worksite personnel and visitor safety system (200) using one or more of: a GPS sensor and transmitter installed with the tractor (119) and included with, or configured to transmit data to, the worksite personnel and visitor safety system (200); and a detection method (e.g., hazard area detection system (254)) that detects the location of the tractor (119) using a given set of camera disposed throughout the safety system worksite (300). The dynamic restricted area (310) is restricted to all visitors and to personnel not designated as operators of the tractor (119). In the example of FIG. 3, the personnel member labelled p4 is said to be a designated operator of the tractor (119). As such, no alert is generated for personnel member p4 being in the dynamic restricted area. FIG. 3 also depicts a limited restricted area (315), where restriction to this area is limited to visitors (i.e., all personnel are permitted in limited restriction area (315)). In other words, the limited restriction area (315) provides an example of a restriction level or categorization associated with a restricted area.

In the example of FIG. 3, the control system (220) of the worksite personnel and visitor safety system (200) is located in Building A (103), however the control system (220) can be located in other locations (e.g., Building B (105), visitor desk (107)) including locations not in the worksite. In some embodiments, an operator (e.g., safety manager) of the worksite personnel and visitor safety system (200) can be stationed at the control system (220). A set of wearable devices are located at the visitor desk (107). Upon entering the safety system worksite (300), a visitor is expected to proceed to the visitor desk (107) and obtain a wearable device (210). FIG. 3 further depicts the first camera (231) and second camera (232) of the gate surveillance system (230) directed at the gate (106) of the safety system worksite (300). The gate surveillance system (230) detects incoming and outgoing vehicles and/or visitors, including identifying information and can automatically update a log (240). Further the gate surveillance (230) can determine whether a visitor has bypassed the visitor gate (106) upon entering or before exiting the safety system worksite (300). Thus, the worksite personnel and visitor safety system (200) can generate an alert if a visitor did not receive or did not return a wearable device (210), where this can be considered an enforcement mechanism of the worksite personnel and visitor safety system (200). FIG. 3 further depicts the third camera (251) of the dock surveillance system (250) including a fourth camera (252). In the example of FIG. 3, the third camera (251) and the fourth camera (252) are each used to acquire images of the docking area (115) but are configured to acquire the images from different perspectives. The different perspectives allow for the determination of spatial data between detected persons (e.g., visitors) and objects (e.g., equipment items and associated hazard areas), e.g., using stereoscope techniques informed by the relative positions and orientations of the cameras.

The safety system worksite (300) can include additional cameras not depicted for detecting persons and objects and tracking their locations.

Using one or more of GPS data (216), gate data (235), and dock data (255), the control system (220) of the worksite personnel and visitor safety system (200) can determine the locations of all personnel and visitors of the safety system worksite (300). The locations of the personnel and visitors can be displayed to an operator of the worksite personnel and visitor safety system (200) using the dashboard (221) and can further include context information such as the map (223) of the safety system worksite (300).

In response to a personnel member or visitor accessing or entering into a restricted area without adequate permission, an alert can is generated using the alert system (222). In the example of FIG. 3, the personnel member labelled p3 is shown as having entered the second restricted area (304) and a first alert (355) is generated by the control system (220) and displayed using the dashboard (221). The example of FIG. 3 further depicts the emission of a distress signal (350) by the wearable device (210) of the personnel member labelled p2, where the distress signal (350) is activated using the SOS button (212) of personnel member p2's wearable device (210). In response to receiving the distress signal (350), the control system (220) of the worksite personnel and visitor safety system (200) can alert relevant parties (e.g., safety manager) including dispatching emergency medical technicians along with informing the relevant parties and dispatched technicians of the location of personnel member p2.

One with ordinary skill in the art will appreciate that the description of the safety system worksite (300) and accompanying figure (FIG. 3) is given as an example and does not necessarily depict the worksite personnel and visitor safety system (200), as described above, in its entirety. For example, the worksite personnel and visitor safety system (200) can include additional cameras disposed throughout the safety system worksite (300) to detect, locate, track, and monitor the location of one or more personnel, visitors, equipment items, vehicles, or combinations thereof and further determine the spatial relationship of these objects or persons to one another or defined restricted areas. That is, the example safety system worksite (300) of FIG. 3 is provided to aid in the discussion of embodiments of the worksite personnel and visitor safety system (200) and should not be considered limiting.

FIG. 4 depicts an example usage of the gate surveillance system (230) as part of the worksite personnel and visitor safety system (200) in accordance with one or more embodiments. FIG. 4 depicts an approaching delivery vehicle (402) at the gate (106) of a worksite. The gate surveillance system (230) includes a first camera (231) and a second camera (232) configured to acquire one or more images of the approaching delivery vehicle (402) at the gate (106). The first camera (231) and the second camera (232) are positioned at different heights. FIG. 4 depicts the first camera (231) at a greater height than the second camera (232), however the reverse can be true. The vehicle identification system (233) of the gate surveillance system (230) processes at least one image from one or more of the first camera (231) and the second camera (232) to determine or extract a vehicle identifier (404) of the approaching delivery vehicle (402). In the example of FIG. 4, the second camera (232), positioned at a lower height than the first camera (231) and with visibility of a front bumper of the approaching delivery vehicle (402), is used to acquire an image including a license plate disposed on the front bumper of the approaching delivery vehicle (402). The image including the license plate is processed by the vehicle identification system (233) using one or more ML models and CV algorithms to extract the vehicle identifier (404) (e.g., a digital text representation of the license plate). In one or more embodiments, the gate surveillance system (230) further determines the load, or materials carried by, the approaching delivery vehicle (402) using a load identification system (234). In some embodiments, the task of load identification is performed by, or performed jointly, using the vehicle identification system (233) such that a separate load identification system (234) is not needed. In the example of FIG. 4, the first camera (231), being positioned at a height greater than the second camera (232) and further positioned such that the load of the approaching delivery vehicle (402) is visible, is used to acquire at least one image including the load. The at least one image is processed using one or more ML models and CV algorithms to determine the load of the approaching delivery vehicle. In FIG. 4, the determined load is stored or output as load contents (406). In one or more embodiments, the load contents (406) indicates a category representative of the type of load such as gravel, pipes, heavy machinery, etc. The gate surveillance system (230) can also determine a vehicle identifier (404) and/or load contents (406) of departing vehicles as well. For example, in one or more embodiments, the first camera (231) and the second camera (232) are rotatable (e.g., attached to a swivel mechanism) and can turn to acquire images of the front or back of a vehicle, as desired, depending on the direction of travel of the vehicle (e.g., approaching or departing). In one or more embodiments, the gate surveillance system (230) further includes one or more proximity sensors to determine whether a vehicle is at the gate (106) and further whether the vehicle is approaching or departing. Thus, proximity data acquired using the one or more proximity sensors can be used to rotate or change the view of the first camera (231) and second camera (232). In accordance with one or more embodiments, the gate surveillance system (230) transmits gate data (235) to the control system (220) of the worksite personnel and visitor safety system (200). The gate data (235) can include one or more of: vehicle identifier (404); load contents (406); and one or more acquired images. In some instances, the one or more acquired images are processed by the control system (220) to determine the vehicle identifier (404) and the load contents (406). Based on one or more of the vehicle identifier (404) and the load contents (406), the control system (220) can update the log (240), prepare the visitor desk (260) (e.g., by configuring a wearable device for an incoming visitor), and generate other alerts as desired.

FIG. 5 depicts an example usage of the dock surveillance system (250) as part of the worksite personnel and visitor safety system (200) in accordance with one or more embodiments. FIG. 5 depicts a docked delivery vehicle (412), i.e., a delivery vehicle in a docking area of a worksite. While in the docking area, materials can be loading onto or unloaded from the docked delivery vehicle (412). In the example of FIG. 5, a materials transport equipment (416) (e.g., a tractor, forklift, etc.) is also depicted in the docking area. The materials transport equipment (416) can be used to load or unload materials from the docked delivery vehicle (412) and move the materials about the worksite. The dock surveillance system (250) includes a third camera (251) directed at the docking area including the docked delivery vehicle (412) and the materials transport equipment (416). In the example of FIG. 5, a delivery driver (414) (i.e., a visitor) of the docked delivery vehicle (412) has exited the docked delivery vehicle (412). In some instances, the docking area can be specified, using the restricted area designation system (270) of the worksite personnel and visitor safety system (200) as a restricted area. For the example of FIG. 5, it is said that the docking area is not a restricted area but a dynamic restricted area is defined as centered on the materials transport equipment (416) with a radius of 5 meters. The dock surveillance system (250) uses images acquired by the third camera (251) (and possibly other cameras such as a fourth camera (252)) to detect a visitor. In one or more implementations, detection of the visitor is performed by processing one or more images of the docking area with a visitor detection system (253). Because detection of the delivery driver (414) is performed based on the one or more images, the location of the delivery driver (414) (or, at least the location of the delivery driver relative to their vehicle such as “in” or “out of” the vehicle) can be determined without the use of a wearable device. For example, in FIG. 5 it is said that the delivery driver (414) has left their wearable device in the docked delivery vehicle (412) and the location of the delivery driver (414) is determined using the dock surveillance system (250) (e.g., visitor detection system (253)) using one or more images of the docking area acquired using at least the third camera (251). In one or more embodiments, the dock surveillance system (250) further determines a hazard area such as a dynamic restricted area, e.g., using a hazard area detection system (254). In some implementations, the task of hazard area detection is performed by the visitor detection system (253) without need for a separate hazard area detection system (254). Detection of a visitor and/or hazard area by the dock surveillance system is performed using one or ML models and/or CV algorithms using one or more images of the docking area acquired using at least the third camera (251). In one or more embodiments, distance between the detected delivery driver (414) and detected hazard area is determined based on the determined locations of the detected delivery driver (414) and detected hazard area, where each may move with time. In accordance with one or more embodiments, the dock surveillance system (250) transmits dock data (255) to the control system (220) of the worksite personnel and visitor safety system (200). The gate data (235) can include one or more of: presence (e.g., out of a vehicle) and location of a visitor (e.g., delivery driver (414)); detected hazard areas (e.g., dynamic hazard area enclosing the materials transport equipment (416)); and one or more acquired images. In some instances, the one or more acquired images are processed by the control system (220) to determine the presence and location of a visitor and hazard areas. Based on one or more of the presence and location of a visitor and hazard areas, the control system (220) can generate alerts to an operator of the worksite personnel and visitor safety system (200). For example, in reference to the example of FIG. 5, the control system (220) can generate an alert in response to the determination that the delivery driver (414) is out of the docked vehicle (412) and in the dynamic hazard area (i.e., within 5 meters from the materials transport equipment (416)). As another example, the control system (220) can generate an alert that the delivery driver (414) has exited the docked delivery vehicle (412) without their wearable device (210).

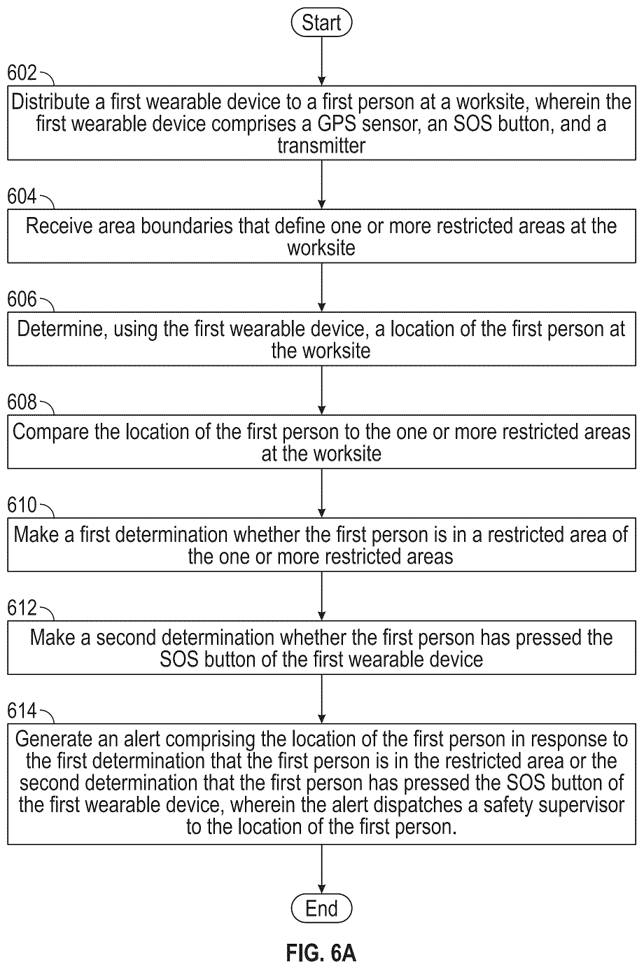

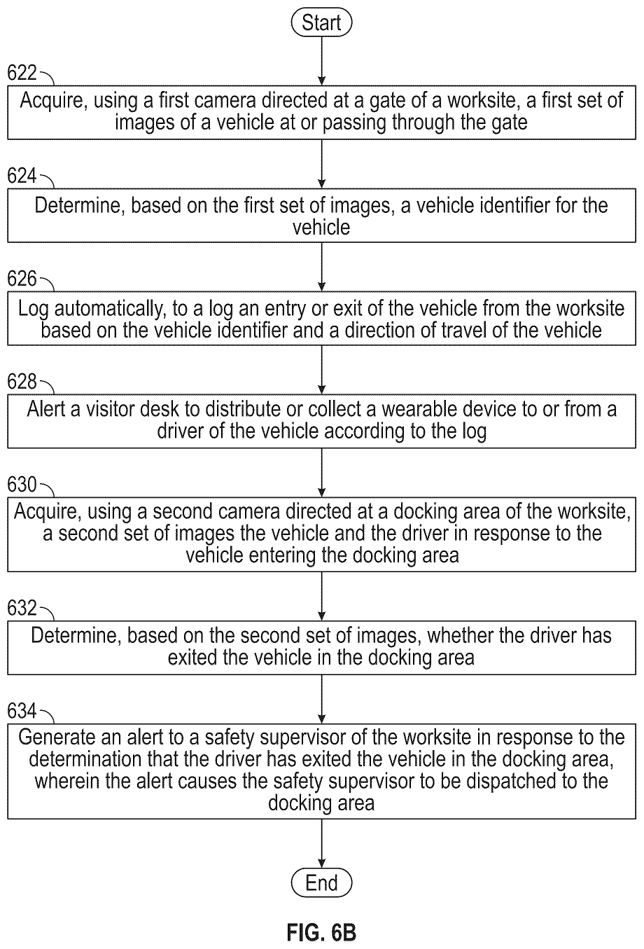

FIGS. 6A and 6B each depict a flowchart outlining the uses of the worksite personnel and visitor safety system, in accordance with one or more embodiments. In particular, FIG. 6A depicts a flowchart describing the use of wearable devices included in the worksite personnel and visitor safety system to locate personnel and/or visitors and generate an alert based on a restricted area violation or reception of a distress signal. In Block 602, a first wearable device is provided to a first person of the worksite. The first person can be a personnel member or a visitor of the worksite. The first wearable device includes a GPS sensor, an SOS button, and a transmitter. In some embodiments, the first wearable device further includes a feedback system and/or power indicator. The first wearable device is configured to communicate with (or at least transmit GPS data to) a control system of the worksite personnel and visitor safety system. The first wearable device communicates using low-power technology as previously described. In Block 604, area boundaries that define one or more restricted areas of the worksite are received. In some embodiments, the one or more restricted areas are each also associated with a categorization or restriction level that indicates which persons (e.g., specific personnel, visitors, etc.) have access to the restricted area. Further, in these embodiments, users of wearable devices can have a set of permissions (or permission set) that outlines which restricted areas they have access to (if any), e.g., based on the restriction level. In Block 606, a location of the first person is determined using the first wearable device. In one or more embodiments, the location is determined using GPS transmitted by the first wearable device, for example, to a control system of the worksite personnel and visitor safety system. The location of the first person can further be displayed using a dashboard including a map of the worksite. In Block 608, the location of the first person is compared to the one or more restricted areas at the worksite. The comparison can include a determination of whether the first person is in a restricted area and, in some instances, whether the permission set of the first person allows the first person in a restricted area based on a restricted level of the restricted area. Specifically, in Block 610 a first determination is made whether the first person is in a restricted area of the one or more restricted areas. In Block 612, a second determination is made whether the first person has pressed the SOS button of the first wearable device. Pressing the SOS button of the first wearable device transmits a distress signal. In Block 614, an alert including the location of the first person is generated in response to either the first or second condition being true. That is, if the first person has entered the restricted area (e.g., without permission based on the permission set of the first person) or has pressed the SOS button on the first wearable device, the alert is generated. In one or more embodiments, the alert dispatches one or more of a safety supervisor and an emergency medical technician (e.g., in response to an alert based on the distress signal) to the location of the first person. In accordance with one or more embodiments, the steps of FIG. 6A can be readily replicated to additional persons such as a second person and a third person. For example, in reference to Block 602, a second wearable device is provided to a second person of the worksite.

FIG. 6B depicts a flowchart describing the use of the gate surveillance system and the dock surveillance system included in the worksite personnel and visitor safety system determine incoming and outgoing vehicles and their drivers (i.e., visitors) and ensure the safety of drivers while unloading/loading materials from their vehicles. In Block 622, a first set of images of a vehicle at a gate of the worksite or passing through the gate of the worksite are acquired using a first camera. In one or more embodiments, the first camera is positioned at a height to acquire images of a specific portion of the vehicle, such as the vehicle bumper. The first set of images can contain one or more images. In Block 624, a vehicle identifier (e.g., a license plate number) is determined for the vehicle based on the first set of images. In one or more embodiments, the vehicle identifier is determined by processing the first set of images with one or more of a ML model and a CV algorithm. Further, in one or more embodiments, the first set of images can be used to determine a direction of travel of the vehicle, e.g., entering or exiting the worksite. In Block 626, a log is automatically updated with the vehicle identifier and a timestamp indicating when the vehicle entered or exited the worksite. In Block 628, a visitor desk is alerted to the activity of the vehicle at the gate. For example, if the vehicle is entering the worksite, the alert to the visitor desk can be to prepare a wearable device for the driver the vehicle. As another example, if the vehicle is exiting the worksite, the alert can indicate that the driver of the vehicle did not return a wearable device. As yet another example, the alert can indicate that the vehicle entered the worksite but did not approach the visitor desk and is thus roaming the worksite unattended and/or without a wearable device. In Block 630, a second set of images of a docking area of the worksite including the vehicle are acquired using a second camera directed at the docking area. The second set of images includes one or more images. The second set of images is acquired in response to the vehicle entering the docking area. In Block 632, it is determined whether the driver of the vehicle has exited (or is outside of) the vehicle in the docking area based on the second set of images. In one or more embodiments, a hazard area in the docking area (e.g., based on a materials transport equipment used to unload/load materials from the vehicle) is also determined using the second set of images and a distance between the driver and the hazard area is determined. The distance can be compared to a predefined threshold. In Block 634, an alert is generated to a safety supervisor of the worksite in response to the determination that the drive has exited the vehicle in the docking area. The alert causes the safety supervisor to be dispatched to the docking area. In some embodiments, the alert is only generated if the distance between the driver that has exited the vehicle and the hazard area is less than the predefined threshold.

Embodiments of the instant disclosure provide one or more of the following advantages. The worksite personnel and visitor safety system (200), as described herein, enables location, tracking, and monitoring of both personnel and visitors of a worksite using combination of wearable devices and cameras. The location of personnel and visitors can be compared to defined restricted areas to determine whether a person is in an unpermitted area. The worksite personnel and visitor safety system (200), in response to determining that a person is in a restricted area without proper authorization, can alert an operator (e.g., safety manager). Further, the worksite personnel and visitor safety system (200) allows for automatic logging of visitors as they enter and exit a worksite. Additionally, wearable devices of the worksite personnel and visitor safety system (200) worn by personnel and visitors are equipped with an SOS button enabling quick alerting of responsible parties in the event of an emergency.

In summary, embodiments disclosed herein relate to a system and method for enhancing the safety of personnel and visitors at a worksite. For example, truck drivers can enter a worksite to unload/load materials (e.g., pipes) on their trucks. Often, while waiting their turn, a truck driver may leave their truck and wonder about the site and enter an unsafe zone. For example, a truck driver may walk on a pipe rack that, if it were to move, would injure or crush the truck driver.

Conventionally, preventing truck drivers from entering unsafe zones is enforced by site personnel, e.g., a loading/unloading operator or a safety officer that monitors the process. However, in instances where the queue of the trucks is long (e.g., exceeding 100 trucks) and/or the site is large it can become difficult to track the behavior of the truck drivers.

The worksite personnel and visitor safety system of the invention tracks personnel (e.g., workers) and visitors (e.g., truck drivers) using computer vision, machine learning, and internet of things (IoT) sensors (e.g., cameras, wearable devices). If a worker or truck driver enters an unsafe zone (or exits a safe zone), an immediate alert will be triggered to a safety manager (i.e., personnel responsible for the safety of the workers).

Personnel are tracked using wearable devices with low power technologies (e.g., BLE/NFC/RFID/WiFi/Zigbee/Matter/Z-wave/LoRa/NB-IoT) and ML-powered cameras. Personnel location and status is monitored on the worksite. The location of a personnel member is logged as a time and point on a map, for example, using a GPS coordinate. The wearable devices worn or carried by personnel are equipped with an SOS button, that once pressed, sends an alert to a control room (e.g., the room that contains the control system or dashboard of the worksite personnel and visitor safety system).

Additionally, truck drivers, upon arrival at the worksite, pass by a gate surveillance system (e.g., with cameras elevated using a pole) to determine the vehicle identifier and load contents using CV and/or ML. That is, the worksite personnel and visitor safety system includes fixed sensors or cameras to detect vehicles entering and exiting the worksite, recognize the license plate or other identifier, and automate a check-in/out process such that an up-to-date log of the vehicle and visitors at the worksite is maintained in real-time. Further, when the truck drivers arrive at the visitor desk, they are given a wearable device similar to personnel. Truck drivers go to their designated areas which are monitored by cameras to load/unload materials. If a truck driver leaves the truck without permission and is spotted by a camera, an alert is triggered to involved parties. The drivers are also tracked using their tracking devices which will trigger an alert if a driver's movement showed that he/she is outside of the truck without permission (e.g., in an unsafe zone). Truck driver's devices are also equipped with SOS button, that once pressed, sends an alert to the control system.

The wearable devices, whether those of the personnel or workers, use direct power source, batteries, or solar power. The wearable devices use a low power technology (e.g., BLE/NFC/RFID/WiFi/Zigbee/Matter/Z-wave/LoRa/NB-IoT).

As stated, the worksite personnel and visitor safety system (200) can include machine learning models. Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein. However, one skilled in the art will recognize that the concepts and methods detailed hereafter are not limited by this choice of nomenclature.

Machine-learned model types used by the worksite personnel and visitor safety system (200) may include, but are not limited to, generalized linear models, Bayesian regression, random forests, and deep models such as neural networks, convolutional neural networks, and vision transformers. Machine-learned model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength.

Commonly, in the literature, the selection of hyperparameters surrounding a machine-learned model is referred to as selecting the model “architecture.” Once a machine-learned model type and hyperparameters have been selected, the machine-learned model is trained to perform a task. For example, a machine-learned model type and associated architecture can be selected and the model trained to detect a vehicle identifier of a vehicle at a gate of a worksite. As another example, in one or more embodiments, a machine learning model is trained to, at least, classify (or assign a type or category to) a load of a vehicle included in an image. Once trained, the performance of machine learning models may be evaluated (e.g., using a partition of training data not seen during training known as a “hold-out set” or “validation set” (or sometimes a “test set”)) and these machine learning models are used in a production setting (also known as deployment of the machine-learned models), where the production setting indicates the use of the machine-learned models by the worksite personnel and visitor safety system (200).

Many machine-learned model architectures are described in the literature for the task of object detection and identification. These machine-learned models are usually based on one or more convolutional neural networks (CNNs). For example, regional based CNNs (R-CNNs) and single shot detectors (SSDs) (and their variants) are commonly employed architectures. Any of these architectures, or others not explicitly referenced herein, may be used by the worksite personnel and visitor safety system (200) without departing from the scope of the instant disclosure. In one or more embodiments, the worksite personnel and visitor safety system (200) includes a machine learning model having a CNN architecture that is based on, or is, the You Only Look Once (YOLO) object detection model. It is noted that various versions of YOLO exist and differ in such things as the types of layers used, resolution of training data, etc. However, a defining trait of all YOLO versions is that multiple objects of varied scales can be detected in a single pass. Further, recent YOLO architectures partition a received input image into grid cells and the grid cells each have one or more associated anchor boxes.

A CNN, such a YOLO, may be more readily understood as a specialized neural network (NN). Thus, a cursory introduction to a NN and a CNN are provided herein. However, it is noted that many variations of a NN and CNN exist. Therefore, one with ordinary skill in the art will recognize that any variation of the NN or CNN (or any other machine-learned model) may be employed without departing from the scope of this disclosure. Further, it is emphasized that the following discussions of a NN and a CNN are basic summaries and should not be considered limiting.

A diagram of a neural network is shown in FIG. 7. At a high level, a neural network (700) may be graphically depicted as being composed of nodes (702), where here any circle represents a node, and edges (704), shown here as directed lines. The nodes (702) may be grouped to form layers (705). FIG. 7 displays four layers (708, 710, 712, 714) of nodes (702) where the nodes (702) are grouped into columns, however, the grouping need not be as shown in FIG. 7. The edges (704) connect the nodes (702). Edges (704) may connect, or not connect, to any node(s) (702) regardless of which layer (705) the node(s) (702) is in. That is, the nodes (702) may be sparsely and residually connected. A neural network (700) will have at least two layers (705), where the first layer (708) is considered the “input layer” and the last layer (714) is the “output layer.” Any intermediate layer (710, 712) is usually described as a “hidden layer”. A neural network (700) may have zero or more hidden layers (710, 712) and a neural network (700) with at least one hidden layer (710, 712) may be described as a “deep” neural network or as a “deep learning method.” In general, a neural network (700) may have more than one node (702) in the output layer (714). In this case the neural network (700) may be referred to as a “multi-target” or “multi-output” network.

Nodes (702) and edges (704) carry additional associations. Namely, every edge is associated with a numerical value. The edge numerical values, or even the edges (704) themselves, are often referred to as “weights” or “parameters.” While training a neural network (700), numerical values are assigned to each edge (704). Additionally, every node (702) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ 1$$

where i is an index that spans the set of “incoming” nodes (702) and edges (704) and f is a user-defined function. Incoming nodes (702) are those that, when viewed as a graph (as in FIG. 7), have directed arrows that point to the node (702) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (702) in a neural network (700) may have a different associated activation function. Often, as a shorthand, activation functions are described by the function ƒ by which it is composed. That is, an activation function composed of a linear function ƒ may simply be referred to as a linear activation function without undue ambiguity.

When the neural network (700) receives an input, the input is propagated through the network according to the activation functions and incoming node (702) values and edge (704) values to compute a value for each node (702). That is, the numerical value for each node (702) may change for each received input. Occasionally, nodes (702) are assigned fixed numerical values, such as the value of 1, that are not affected by the input or altered according to edge (704) values and activation functions. Fixed nodes (702) are often referred to as “biases” or “bias nodes” (706), displayed in FIG. 7 with a dashed circle.

In some implementations, the neural network (700) may contain specialized layers (705), such as a normalization layer, or additional connection procedures, like concatenation. One skilled in the art will appreciate that these alterations do not exceed the scope of this disclosure.

As noted, the training procedure for the neural network (700) comprises assigning values to the edges (704). To begin training the edges (704) are assigned initial values. These values may be assigned randomly, assigned according to a prescribed distribution, assigned manually, or by some other assignment mechanism. Once edge (704) values have been initialized, the neural network (700) may act as a function, such that it may receive inputs and produce an output. As such, at least one input is propagated through the neural network (700) to produce an output. Training data is provided to the neural network (700). Generally, training data consists of pairs of inputs and associated targets. The targets represent the “ground truth,” or the otherwise desired output, upon processing the inputs. In the context of the instant disclosure, an input can be an image, for example of a gate with a vehicle, its associated target is a data structure indicating the location (e.g., bounding box) and class (i.e., class label) of any vehicle identifiers (e.g., license plate) present on the vehicle.

During training, the neural network (700) processes at least one input from the training data and produces at least one output. Each neural network (700) output is compared to its associated input data target. The comparison of the neural network (700) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (700) output and the associated target. The loss function may also be constructed to impose additional constraints on the values assumed by the edges (704), for example, by adding a penalty term, which may be physics-based, or a regularization term (not be confused with regularization of seismic data). Generally, the goal of a training procedure is to alter the edge (704) values to promote similarity between the neural network (700) output and associated target over the training data. Thus, the loss function is used to guide changes made to the edge (704) values, typically through a process called “backpropagation.”

While a full review of the backpropagation process exceeds the scope of this disclosure, a brief summary is provided. Backpropagation consists of computing the gradient of the loss function over the edge (704) values. The gradient indicates the direction of change in the edge (704) values that results in the greatest change to the loss function. Because the gradient is local to the current edge (704) values, the edge (704) values are typically updated by a “step” in the direction indicated by the gradient. The step size is often referred to as the “learning rate” and need not remain fixed during the training process. Additionally, the step size and direction may be informed by previously seen edge (704) values or previously computed gradients. Such methods for determining the step direction are usually referred to as “momentum” based methods.

Once the edge (704) values have been updated, or altered from their initial values, through a backpropagation step, the neural network (700) will likely produce different outputs. Thus, the procedure of propagating at least one input through the neural network (700), comparing the neural network (700) output with the associated target with a loss function, computing the gradient of the loss function with respect to the edge (704) values, and updating the edge (704) values with a step guided by the gradient, is repeated until a termination criterion is reached. Common termination criteria are: reaching a fixed number of edge (704) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (704) values are no longer intended to be altered, the neural network (700) is said to be “trained.”

A CNN is similar to a neural network (700) in that it can technically be graphically represented by a series of edges (704) and nodes (702) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. Images have such a structural relationship. Consequently, a CNN is an intuitive choice for detecting objects in images as images have such a spatial relationship (i.e., the order of pixels does not change).

A structural grouping, or group, of weights is herein referred to as a “filter.” The number of weights in a filter is typically much less than the number of inputs, where here the number of inputs refers to the number of pixels in an image. In a CNN, the filters can be thought as “sliding” over, or convolving with, the inputs to form an intermediate output or intermediate representation of the inputs which still possesses a structural relationship. Like unto the neural network (700), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (700) to produce a final output. Note, that in this context, the neural network (700) is still considered part of the CNN. Like unto a neural network (700), a CNN is trained, after initialization of the filter weights, and the edge (704) values of the internal neural network (700), if present, with the backpropagation process in accordance with a loss function.

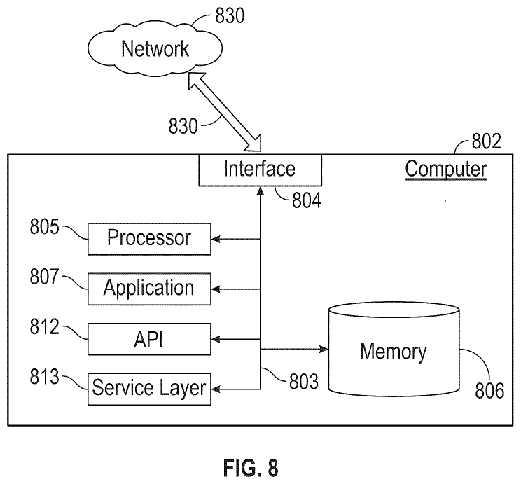

FIG. 8 depicts a block diagram of a computer system (802) used to provide computational functionalities associated with described algorithms, methods, functions, processes, flows, and procedures as described in this disclosure, according to one or more embodiments. The illustrated computer (802) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804) includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). The memory may be a non-transitory computer readable medium. For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), wherein each computer (802) communicates over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
distributing a first wearable device to a first person at a worksite, wherein the first wearable device comprises a GPS sensor, an SOS button, and a transmitter;
receiving area boundaries that define one or more restricted areas at the worksite;
determining, using the first wearable device, a location of the first person at the worksite;
comparing the location of the first person to the one or more restricted areas at the worksite;
making a first determination whether the first person is in a restricted area of the one or more restricted areas;
making a second determination whether the first person has pressed the SOS button of the first wearable device;
generating an alert comprising the location of the first person in response to the first determination that the first person is in the restricted area or the second determination that the first person has pressed the SOS button of the first wearable device, wherein the alert dispatches a safety supervisor to the location of the first person.

2. The method of claim 1, wherein the first person is a personnel member or visitor of the worksite.

3. The method of claim 1, wherein the first wearable device further comprises a feedback system that can provide one or more of a audio tone, a visual signal, and a haptic force to the first person.

4. The method of claim 3, wherein the feedback system of the first wearable device is activated in response to the alert.

5. The method of claim 1, further comprising:
receiving a restriction level for each of the one or more restricted areas,
wherein making the first determination further comprises determining that access to the restricted area is not permitted for the first person based on a restriction level of the restricted area and a permission set of the first person.

6. The method of claim 1, further comprising displaying the location of the first person on a map of the worksite.

7. A method, comprising:
acquiring, using a first camera directed at a gate of a worksite, a first set of images of a vehicle at or passing through the gate;
determining, based on the first set of images, a vehicle identifier for the vehicle;
logging, automatically, to a log an entry or exit of the vehicle from the worksite based on the vehicle identifier and a direction of travel of the vehicle;
alerting a visitor desk to distribute or collect a wearable device to or from a driver of the vehicle according to the log;
acquiring, using a second camera directed at a docking area of the worksite, a second set of images the vehicle and the driver in response to the vehicle entering the docking area;
determining, based on the second set of images, whether the driver has exited the vehicle in the docking area;
generating an alert to a safety supervisor of the worksite in response to the determination that the driver has exited the vehicle in the docking area, wherein the alert causes the safety supervisor to be dispatched to the docking area.

8. The method of claim 7, wherein determining the vehicle identifier is performed using one or more of a machine learning model and a computer vision algorithm.

9. The method of claim 7, further comprising determining, based on the first set of images, a load of the vehicle.

10. The method of claim 7, further comprising determining, based on the second set of images, a hazard area in the docking area and a distance between the driver and the hazard area.

11. The method of claim 10, further comprising:
comparing the distance to a threshold and generating another alert to the safety supervisor in response to the distance violating the threshold.

12. The method of claim 10, wherein the hazard area is located at a materials transport equipment of the worksite.

13. The method of claim 12, wherein the hazard area is defined using a specified radius about the materials transport equipment.

14. A system, comprising:
one or more wearable devices, wherein one wearable device is distributed to each personnel member and visitor of a worksite, wherein each wearable device comprises a GPS sensor, an SOS button, and a transmitter;
a gate surveillance system proximate a gate of the worksite, wherein the gate surveillance system comprises a first camera and a second camera directed at the gate;
a dock surveillance system proximate a docking area of the worksite, wherein the dock surveillance system comprises a third camara directed at the docking area; and
a control system comprising one or more computer processors, the control system configured to:
obtain GPS data from each distributed wearable device, wherein the GPS data comprises a location of each distributed wearable device,
obtain gate data from the gate surveillance system,
obtain dock data from the dock surveillance system,
receive area boundaries that define one or more restricted areas at the worksite;
display, to a dashboard including a map of the worksite, the location of each wearable device based on the GPS data of each wearable device,
make a first determination, based on the GPS data from a first wearable device and the area boundaries, whether the first wearable device has entered a restricted area of the one or more restricted areas,
generate a first alert comprising the location of the first wearable device in response to the first determination that the first wearable device has entered the restricted area, wherein the first alert causes a safety supervisor of the worksite to be dispatched to the location of the first wearable device,
determine, based on the gate data, a vehicle identifier for a first vehicle at, or passing through, the gate,
log, to a log, an entry or exit of the first vehicle to or from the worksite based on the vehicle identifier and an indication of a direction of travel of the first vehicle,
make a second determination, based on the dock data, whether a driver of a second vehicle at the docking area is outside of the second vehicle, and
generate a second alert to the safety supervisor in response to the second determination that the driver is outside the second vehicle, wherein the second alert causes the safety supervisor of the worksite to be dispatched to the docking area.

15. The system of claim 14, wherein the control system is further configured to:
receive a distress signal from as second wearable device, wherein the distress signal is activated using the SOS button of the second wearable device, and
generate a third alert in response to receiving the distress signal, wherein the third alert causes one or more of the safety supervisor and an emergency medical technician to be dispatched to the location of the second wearable device based on its GPS data.

16. The system of claim 14, wherein each wearable device further comprises a feedback system that can provide one or more of a audio tone, a visual signal, and a haptic force to its user.

17. The system of claim 16, wherein the control system is further configured to transmit an alert command to the first wearable device in response to the first determination that the first wearable device has entered the restricted area, wherein alert command activates the feedback system of the first wearable device.

18. The system of claim 14, wherein the control system is further configured to:
receive a restriction level for each of the one or more restricted areas,
wherein making the first determination further comprises determining that access to the restricted area is not permitted for the first wearable device based on a restriction level of the restricted area and a permission set of its user.

19. The system of claim 14, wherein the control system is further configured to determine, based on the gate data, a load of the first vehicle.

20. The system of claim 14, wherein the control system is further configured to:
determine, based on the dock data, a hazard area in the docking area and a distance between the driver and the hazard area;
compare the distance to a threshold and generate a third alert to the safety supervisor in response to the distance violating the threshold.
